(19) United States
(12) Patent Application Publication
(10) Pub. No.: US 2026/0358125 A1
(43) Pub. Date: Nov. 12, 2026

(54) QUANTUM SENSOR AND METHOD FOR PRODUCING SAME

(71) Applicants: GOTTFRIED WILHELM LEIBNIZ UNIVERSITÄT HANNOVER, Hannover (DE); DEUTSCHES ZENTRUM FÜR LUFT- UND RAUMFAHRT E.V., Bonn-Oberkassel (DE)

(72) Inventors: Ernst M. RASEL, Hannover (DE); Hendrik HEINE, Langenhagen (DE); Waldemar HERR, Hannover (DE); Christian SCHUBERT, Hannover (DE); Alexander KASSNER, Söhlde (DE); Christopher WURZ, Hannover (DE)

(21) Appl. No.: 19/490,636

(22) PCT Filed: Jul. 15, 2024
(86) PCT No.: PCT/EP2024/069978

§ 371 Date: Dec. 5, 2025

(30) Foreign Application Priority Data
Jul. 17, 2023 (DE) 10 2023 118 819.4

(51) Int. Cl. G01C 19/58

(52) U.S. Cl. CPC G01C 19/58

(57) ABSTRACT

The invention relates to a quantum sensor, in particular an atomic interferometer. The invention also relates to a method for producing such a quantum sensor.

The invention relates to a quantum sensor, in particular an atomic interferometer. The invention also relates to a method for producing such a quantum sensor.

A quantum sensor is a sensor device which can sense physical quantities, for example accelerations, with high precision by using properties of quantum mechanics, for example quantum entanglement, quantum interference or quantum state squeezing. The quantum sensor may, for example, be configured as an atom interferometer. An atom interferometer is an interferometer which uses the wave properties of atoms. Atom interferometers may for example be used as accelerometers, rotation sensors or gravity gradiometers. An atom interferometer is known, for example, from EP 3 899 990 A1 .

The object of the invention is to provide a further improved quantum sensor and a method for its production.

This object is achieved by a quantum sensor as claimed in claim 1. The quantum sensor, which may for example be configured as an atom interferometer, has the following features:
at least one system for holding at least one atom in an atom trap region,
at least one optical trap device for trapping the at least one atom in the atom trap region by optical signals, the sensor device having at least one first light source which is adapted to emit light with a first wavelength,
at least one optical sensor device for sensing at least one physical quantity of the at least one atom trapped in the atom trap region, the optical trap device having at least one second light source which is adapted to emit light with a second wavelength,
wherein at least one optically functionalized layer, by which the light emitted by the first and/or second light source is reflected and/or deviated, is arranged in the light beam path from the first light source (1) and/or the second light source to the system for holding at least one atom.

The invention has the advantage that the design and equipment outlay for producing such a quantum sensor may be reduced considerably in comparison to known solutions. In particular, for producing the optical trap device it is not necessary to use a plurality of separate first light sources which emit light onto the atom trap region from different directions, or to generate such light emission with a complex mirror arrangement. The quantum sensor according to the invention may be produced in particular with an optical trap device which has only a single first light source, for example a controllable laser. The light beam characteristic required for the process of optically trapping an atom in the atom trap region may then be produced by suitable configuration of the optically functionalized layer, which has suitable reflecting and/or light-deviating characteristics. For example, the one first light source may emit the light onto the optically functionalized layer, where the beam characteristic desired in the atom trap region may be produced by suitable reflection and/or light deviation.

A further advantage of the invention is that the quantum sensor may also be optimized in terms of the arrangement and configuration of the optical sensor device. In particular, significant miniaturization is possible in comparison to known solutions. For instance, the second light source in the quantum sensor according to the invention may be arranged in such a way that the light emission direction of the second light source can be configured so that it is parallel to and/or overlaps with the light emission direction of the first light source. This also allows significant miniaturization.

Advantageously, because of the design characteristics explained above, the quantum sensor according to the invention may be produced particularly well with microtechnology method steps, for example for the generation of the at least one optically functionalized layer, which may for example be applied directly on the system for holding at least one atom. The system for holding at least one atom may, for example, be configured as an atom chip or have an atom chip.

In principle, it is possible for the first wavelength to be the same as the second wavelength. In one advantageous embodiment of the invention, the first wavelength is a different wavelength to the second wavelength. In this way, in particular, further advantageous effects may be achieved with a reflection layer having wavelength-specific reflection properties. In addition, the first light source may be adjustable in respect of the wavelength of the emitted light, at least in a small wavelength range, in order temporarily to produce a wavelength shift, for example into the blue range or the red range. For example, the first wavelength may be about 780 nm and the second wavelength may be about 795 nm.

By the optical trap device, in particular, cooling of the individual atoms in the atom trap region may be carried out, in particular cooling to temperatures in the microkelvin range.

The system may additionally have a magnetic trap device for trapping or holding the at least one atom in the atom trap region. The magnetic trap device may, for example, be adapted to generate a quadrupole magnetic field in the atom trap region. By energizing the electrical lines of an electromagnet device of the magnetic trap device, the atoms trapped by the optical trap device may be held in the atom trap region and therefore stored there. Further cooling of the atoms may, for example, be carried out by evaporative cooling.

The device, in particular the quantum sensor, may also have an atom emitter which provides the at least one atom that is intended to be trapped in the atom trap region for measurement purposes. For example, the atom emitter may be configured as a dispenser. Appropriate materials for providing the atoms to be analyzed are, for example, alkali metals or rubidium.

According to one advantageous embodiment of the invention, the at least one optically functionalized layer is arranged between the atom trap region and the system, particularly in the immediate vicinity of the system, or is applied on the surface of the system. In this way, the effectiveness of the optically functionalized layer may be further optimized. In addition, the quantum sensor may be further miniaturized.

According to one advantageous embodiment of the invention, the at least one optically functionalized layer has at least one optical reflection layer by which the light incident from the first and/or second light source is reflected at least partially onto the at least one optically functionalized layer. In this way, for example, particular light components of the light incident on the at least one optically functionalized layer may be reflected while other light components may for example be transmitted through the optical reflection layer.

According to one advantageous embodiment of the invention, the at least one optical reflection layer is adapted for the wavelength-specific reflection of light, in such a way that light of the second wavelength is reflected fully or predominantly and light of the first wavelength is transmitted fully or predominantly by the optical reflection layer. This has the advantage that the light emitted by the sensor device substantially cannot penetrate through the optical reflection layer but is reflected back, while the light of the first light source can pass through the optical reflection layer and, for example, thereby impinge on a downstream optical deviating layer. This makes it possible that the light of the first light source can reach the atom trap region with a different beam characteristic than the light of the second light source. For example, the at least one optical reflection layer may be constructed as a Bragg mirror. Such a Bragg mirror may be produced from alternating thin layers with different refractive indices. In one advantageous embodiment, the layers may consist of dielectrics.

According to one advantageous embodiment of the invention, the at least one optically functionalized layer has at least one optical deviating layer by which the light incident on the at least one optically functionalized layer from the first and/or second light source is deviated at a return beam angle different to the angle of incidence, particularly in the direction of the atom trap region. This has the advantage that the light which reaches the optical deviating layer can be deviated at a desired return beam angle, for example back in the direction of the atom trap region. The at least one deviating layer may, for example, have at least one optical grating in which the optical deviation takes place by diffraction at the grating. The at least one optical deviating layer may also involve different types of optical deviation, for example an arrangement consisting of a multiplicity of micromirrors and/or microprisms.

In one advantageous embodiment, the at least one optically functionalized layer or at least the deviating layer may be configured as a passive, non-controllable layer. This further reduces the outlay for the production of the quantum sensor and improves the possibilities for miniaturization.

In the context of the present application, reflection is to be regarded in particular as a characteristic of the optical reflection layer, with which light incident orthogonally on the optical reflection layer is in turn reflected back orthogonally and therefore parallel to the incident light. Optical deviation in the context of the present application means in particular a property of the optical deviating layer by which it deviates light incident orthogonally on the optical deviating layer in a direction different to the orthogonal direction. The light incident orthogonally on the optical deviating layer is therefore deviated in a return beam direction that is not parallel to the angle of incidence.

According to one advantageous embodiment of the invention, the at least one optical deviating layer is arranged behind the at least one optical reflection layer as seen by the first and/or second light source. This has the advantage that only the part of the light of the first and second light sources that can pass through the optical reflection layer reaches the optical deviation layer.

According to one advantageous embodiment of the invention, the at least one optical deviating layer is divided into a plurality of subsections, for example into at least three subsections, each subsection having a different deviation direction of the incident light than the other subsections. In this way, with little outlay and in particular with a very small overall size, it is possible to produce a complex light guiding characteristic by which, in particular, the at least one atom can be trapped in three spatial directions in the atom trap region. In particular, the at least one optical deviating layer may be configured with its subsections in such a way that the light from all subsections is deviated in the direction of the atom trap region. The plurality of subsections of the deviating layer may be arranged next to one another on the same plane, although they may also lie in planes that are offset slightly with respect to one another.

According to one advantageous embodiment of the invention, the at least one optical deviating layer is planarized by means of a planarization layer at least on the side facing toward the at least one optical reflection layer. This has the advantage that if the optical deviating layer has surface irregularities when it is produced, these can be evened out by means of the planarization layer. Particularly if the deviating layer is produced with an optical grating, the irregularities of the grating structures can thereby be compensated. Accordingly, the optical reflection layer arranged on the optical deviating layer may likewise be produced as a plane, smooth layer. For example, a thin layer of spin-on glass (SoG) may be applied as a planarization layer on the optical deviating layer, for example with a layer thickness of at most 10 μm, in particular at most 5 μm or at most 1 μm.

According to one advantageous embodiment of the invention, the at least one optical deviating layer is arranged on a substrate or has a substrate, electrical interconnects being integrated in the substrate. In this way, the overall structure of the quantum sensor may be made even more compact. For example, the electrical interconnects arranged in the substrate may be used as part of an electromagnet device for generating a magnetic field of a magnetic trap device of the quantum sensor.

According to one advantageous embodiment of the invention, the light emission direction of the first light source is aligned parallel to and/or overlaps with the light emission direction of the second light source. In this way, the structure of the quantum sensor may be further miniaturized.

According to one advantageous embodiment of the invention, at least the at least one optically functionalized layer is configured as a microtechnology layer. This also allows further miniaturization of the quantum sensor. The microtechnology layers may be applied by known microtechnology methods, in particular conventional CVD and PVD methods. For example, the at least one reflection layer may have a thickness of at most 20 μm or at most 10 μm. The at least one optical deviating layer may have a thickness of at most 20 μm or at most 10 μm. In particular, if the grating structure is configured as an optical grating, the thickness of the optical deviating layer may have a thickness of at most 200 nm. Added to this is the thickness of a substrate layer, on which such an at most 200 nm thick layer of the optical grating may be applied.

The object mentioned in the introduction is furthermore achieved by a method for producing a quantum sensor of the type explained above, in which the at least one optically functionalized layer is applied by means of microtechnology methods on the system for holding at least one atom. This allows very rational production of the quantum sensor having the advantageous properties explained above, in particular a highly miniaturized quantum sensor. For example, the system may initially be provided as a component and the partial layers of the at least one optically functionalized layer may then be applied thereon, for example first the optical deviating layer and then the optical reflection layer. In addition, the aforementioned planarization layer may also be applied on the optical deviating layer before the application of the optical reflection layer.

The invention is explained in more detail below with the aid of exemplary embodiments by using drawings, in which:

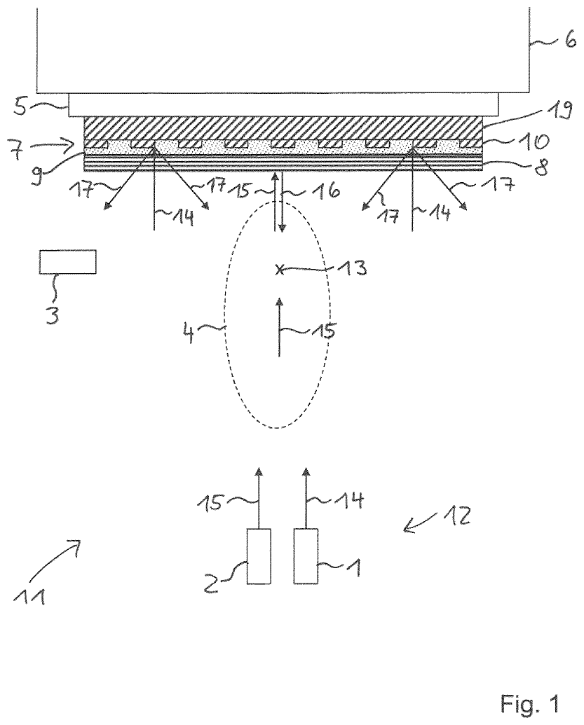

FIG. 1 shows a quantum sensor in a lateral sectional view,

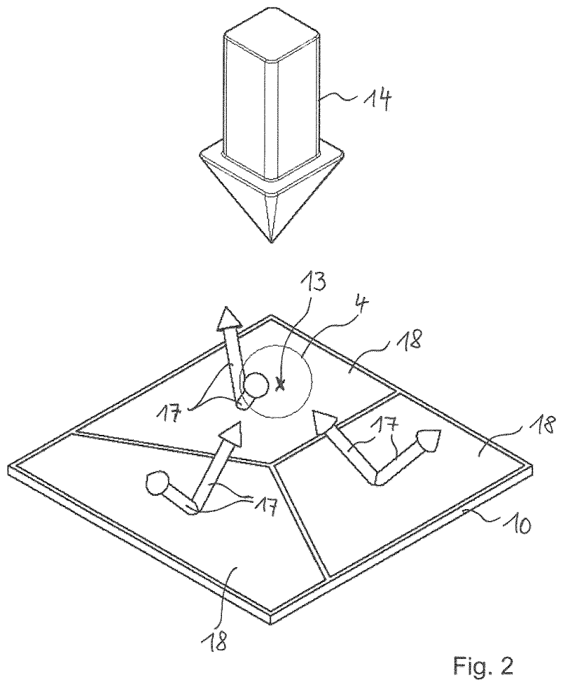

FIG. 2 shows an embodiment of an optically functionalized layer of the quantum sensor in a perspective view,

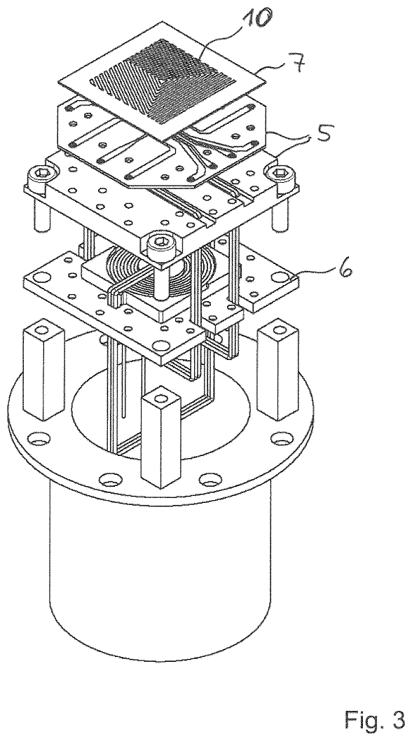

FIG. 3 shows a possible embodiment of a magnetic trap device of the quantum sensor.

FIG. 1 shows a quantum sensor which has a system 5 for holding at least one atom 13 in an atom trap region 4. The quantum sensor further has an optical trap device 12 for trapping the at least one atom 13 in the atom trap region 4 by optical signals of a first light source 1 of the optical trap device 12. The first light source 1 is adapted to emit light 14 with a first wavelength. The quantum sensor further has an optical sensor device 11 for sensing at least one physical quantity of the at least one atom 13 trapped in the atom trap region 4. For this purpose, the optical sensor device 11 has a second light source 2, which is adapted to emit light 15 with a second wavelength. In order to carry out measurements on the atom 13, the sensor device 11 has for example a measuring device 3, for example an optical interferometer.

In the light beam path of the light 14 from the first light source 1 and/or of the light 15 from the second light source 2 to the system 5, the quantum sensor has at least one optically functionalized layer 7. The optically functionalized layer 7 has an optical deviating layer 10, which may be applied on the system 5 either directly or via at least one intermediate layer. Since the optical deviating layer 10 may be relatively thin, particularly in the configuration as a grating, the optical deviating layer 10 may be applied on a substrate 19.

Applied on the optical deviating layer 10, there is an optical reflection layer 8. In order to planarize possible irregularities on the surface of the optical deviating layer 10 facing toward the optical reflection layer 8, a planarization layer 9 may be applied on the optical deviating layer 10. The optical reflection layer 8 is then applied thereon. The quantum sensor may further have a magnetic trap device 6 with a magnetic field generator, in order for the atoms 13 trapped in the atom trap region 4 to be held there additionally by magnetic fields.

It can be seen that the light 15 emitted by the light source 2 which strikes the optical reflection layer 8 is reflected substantially fully as reflected light 16. Conversely, the optical reflection layer 8 is transparent for the light 14 of the first light source 1 so that it strikes the optical deviating layer 10 and is deviated and scattered there as light rays 17 in different directions, for example by diffraction at the grating.

By means of such an optically functionalized layer, it is possible to produce a miniaturized optical trap device 12 in which the atoms 13 can be trapped in the atom trap region 4 in all three spatial directions, for example for an atom interferometer. This is explained by way of example with the aid of FIG. 2. In the embodiment of FIG. 2, the optical deviating layer 10 is divided into three subsections 18. The subsections 18 each have different deviation directions, with the result that the light rays 14 of the first light source 1 which strike the optical deviating layer 10 are deviated and scattered in different directions so that a substantial part of the scattered light 17 from all the subsections 18 converges in the atom trap region 4. By suitable light emission of the light rays 14 and a suitable small variation of the wavelength of the light 14, the atom 13 can be held at a particular position by light 14 and light 17 impinging on the atom 13.

FIG. 3 depicts an advantageous structure of the magnetic trap device 6 in combination with the system 5 as well as the optically more functional layer 7. For example, the system 5 may be constructed from a plurality of individual parts or layers. The magnetic trap device 6 may have mesoscopic structures for generating a quadrupole magnetic field in the atom trap region 4.

As mentioned, electrical interconnects may be integrated in the substrate 19. For this, indentations may initially be etched into the substrate during the production of the substrate 19. In accordance with the substrate material, an electrical insulation layer is applied, followed by adhesion promoter layers and electrical start layers, before the indentation is electrolytically filled. Because of the geometry of the indentation, amplifications of the electric field may take place in the region of the edges during the electrodeposition. This results in excessive growth in these regions, which leads to the formation of “edge walls”. For planarization, chemical-mechanical polishing (CMP) may be applied, for example, which is a common method of microtechnology. Since the adhesion of layers to the gold/copper interconnects of the system is not optimal, the upper side of the interconnects may be provided with an adhesion promoter layer, which is suitably structured and is present only on the interconnects themselves but not on other regions of the substrate, since short circuits would otherwise occur. This is followed by a further layer of SIO₂, which forms the foundation for the subsequent optically functionalized layer 7 and simultaneously acts as an electrical insulator. Alternatively, an Al₂O₃ layer may also be used.

In order to produce the optical deviating layer 10, for example in the form of an optical grating, at least three procedures are available, depending on the design requirement:
1. The material for the grating is deposited surface-wide, with the layer thickness corresponding at least to the height of the grating. This is followed by structuring by means of lithography and etching techniques.
2. The material for the grating is deposited surface-wide. This is followed by the application and structuring of a photoresist. In a next step, the material for the grating is again deposited surface-wide and structured by lift-off of the photoresist.
3. The SIO₂ top layer (or alternatively a different top layer) of the system is structured directly, (cf. point 1). The actual grating material is then applied as a top layer onto the prestructured structure.

Optical coatings without a grating may be deposited directly onto the top layer of the system.

Optical coatings on optical gratings firstly require a plane surface, for which purpose the gaps of the optical gratings need to be “filled”. One advantageous possibility in this case consists in applying a thin layer of spin-on glass (SoG) of the order of up to 1 μm (the indentations of the gratings are in the low three-digit nm range). The SoG partially evens out the indentations, and a CMP step is additionally employed in order to achieve final planarization. The optical coating is then applied thereon as described above.

1. A quantum sensor, comprising:
at least one system for holding at least one atom in an atom trap region;
at least one optical trap device for trapping the at least one atom in the atom trap region by optical signals, wherein the at least one optical trap device comprises at least one first light source adapted to emit light at a first wavelength;
at least one optical sensor device for sensing at least one physical quantity of the at least one atom trapped in the atom trap region, wherein the at least one optical sensor trap device comprises at least one second light source adapted to emit light at a second wavelength; and
at least one optically functionalized layer by which light emitted by the first light source and/or light emitted by the second light source is reflected and/or deviated, wherein the at least one optically functionalized layer is arranged in a light beam path from the first light source and/or a light beam path from the second light source to the at least one system.

2. The quantum sensor as claimed in claim 1, wherein the at least one optically functionalized layer is arranged between the atom trap region and the at least one system, or the at least one optically functionalized layer is applied on a surface of the at least one system.

3. The quantum sensor as claimed in claim 1, wherein the at least one optically functionalized layer has at least one optical reflection layer by which light incident from the first light source and/or light incident from the second light source is reflected at least partially onto the at least one optically functionalized layer.

4. The quantum sensor as claimed in claim 3, wherein the at least one optical reflection layer is adapted for a wavelength-specific reflection of light such that light of the second wavelength is reflected fully or predominantly and light of the first wavelength is transmitted fully or predominantly by the at least one optical reflection layer.

5. The quantum sensor as claimed in claim 1, wherein the at least one optically functionalized layer has at least one optical deviating layer by which light incident on the at least one optically functionalized layer from the first light source and/or the second light source is deviated at a return beam angle different to an angle of incidence.

6. The quantum sensor as claimed in claim 5, wherein the at least one optical deviating layer is arranged behind the at least one optical reflection layer relative to the first light source and/or the second light source.

7. The quantum sensor as claimed in claim 5, wherein the at least one optical deviating layer is divided into a plurality of subsections, wherein each subsection of the plurality of subsections has a different deviation direction of incident light than the other subsections of the plurality of subsections.

8. The quantum sensor as claimed in claim 5, wherein the at least one optical deviating layer is planarized by a planarization layer at least on a side facing toward the at least one optical reflection layer.

9. The quantum sensor as claimed in claim 5 wherein one the at least one optical deviating layer is arranged on a substrate, or the at least one optical deviating layer has a substrate, and further comprising electrical interconnects integrated in the substrate.

10. The quantum sensor as claimed in claim 1 wherein a light emission direction of the first light source is aligned parallel to and/or overlaps with a light emission direction of the second light source.

11. The quantum sensor as claimed in claim 1 wherein the least at least one optically functionalized layer is configured as a microtechnology layer.

12. The quantum sensor as claimed in claim 1 wherein the at least one system has an atom chip or is configured as an atom chip.

13. A method for producing a quantum sensor as claimed in claim 1, comprising applying the at least one optically functionalized layer to the at least one system by microtechnology methods.

14. The quantum sensor of claim 5 wherein the angle of incidence is in a direction of the atom trap region.
